(19) United States
(12) Patent Application Publication
(10) Pub. No.: US 2018/0365067 A1
(43) Pub. Date: Dec. 20, 2018

(54) Method for Assigning Installation Task and Terminal Device

(71) Applicant: Guangdong Oppo Mobile Telecommunications Corp., Ltd., Dongguan (CN)

(72) Inventor: Yuanqing Zeng, Dongguan (CN)

(21) Appl. No.: 16/119,145

(22) Filed: Aug. 31, 2018

Related U.S. Application Data
(63) Continuation of application No. PCT/CN2017/086446, filed on May 27, 2017.

(30) Foreign Application Priority Data
May 31, 2016 (CN) 201610380701.1

(51) Int. Cl. G06F 9/50; G06F 8/61

(52) U.S. Cl. CPC G06F 9/505; G06F 2209/501; G06F 2209/503; G06F 8/61

(57) ABSTRACT

A method for assigning an installation task and a terminal device are provided. The method includes the following. Available processor resources are queried according to operation levels of processor resources in response to a start signal for an installation task of an application detected. The installation task is assigned to the available processor resources for executing when the available processor resources are queried. A performance index of the available processor resources is improved.

### CROSS-REFERENCE TO RELATED APPLICATION(S)

This application is a continuation of PCT/CN2017/086446, filed on May 27, 2017, which claims priority to Chinese Patent Application No. 201610380701.1, filed on May 31, 2016, the contents of both of which are hereby incorporated by reference in their entireties.

### TECHNICAL FIELD

This disclosure relates to the field of terminal devices, and particularly to a method for assigning an installation task and a terminal device.

### BACKGROUND

At present, an increasing number of applications, that can implement multiple functions, are installed on terminal devices such as mobile terminals, meaning that an increasing number of running tasks of applications need to be executed by a processor of the terminal device. The processor of the terminal device may also have to execute installation tasks of the applications during executing the running tasks. However, an operating system of the terminal device does not have an ability of intelligently identifying the installation tasks of the applications, causing that the installation tasks cannot be assigned to effective processor resources for quick executing, thereby reducing an installation speed of the application and further reducing the user experience.

### SUMMARY

A method for assigning an installation task and a terminal device are provided, which permit installation tasks of an application to be assigned to effective processor resources for quick executing, therefore improving an installation speed of the application and further improving the user experience.

According to a first aspect of the disclosure, a method for assigning an installation task is provided. The method includes the following. Available processor resources are queried according to operation levels of processor resources in response to a start signal for an installation task of an application detected. The installation task is assigned to the available processor resources for executing when the available processor resources are queried. A performance index of the available processor resources is improved.

According to a second aspect of the disclosure, a terminal device is provided. The terminal device includes at least one processor and a computer readable storage coupled to the at least one processor and storing at least one computer executable instruction thereon. The at least one computer readable storage, when executed by the at least one processor, cause the device to carry out the following actions. Available processor resources are queried according to operation levels of processor resources in response to a start signal for an installation task of an application detected. The installation task is assigned to the available processor resources for executing when the available processor resources are queried. A performance index of the available processor resources is improved.

According to a third aspect of the disclosure, a non-transitory computer readable storage medium for storing at least one computer executable instruction is provided. The at least one computer executable instruction, when executed by a computer, can cause the computer to carry out the following actions. Available processor resources are queried according to operation levels of processor resources in response to a start signal for an installation task of an application detected. The installation task is assigned to the available processor resources for executing when the available processor resources are queried. A performance index of the available processor resources is improved.

### BRIEF DESCRIPTION OF THE DRAWINGS

To illustrate technical solutions embodied by the implementations of the present disclosure more clearly, the following briefly introduces the accompanying drawings required for describing the implementations.

FIG. 1 is a schematic flow chart illustrating a method for assigning an installation task according to an implementation of the disclosure.

FIG. 2 is a schematic flow chart illustrating a method for assigning an installation task according to an implementation of the disclosure.

FIG. 3 is a block diagram illustrating functional units of an apparatus for assigning an installation task according to an implementation of the disclosure.

FIG. 4 is a schematic structural diagram illustrating a terminal device according to an implementation of the disclosure.

FIG. 5 is a schematic structural diagram illustrating another terminal device according to an implementation of the disclosure.

### DETAILED DESCRIPTION

Hereinafter, technical solutions embodied in implementations of the disclosure will be described in a clear and comprehensive manner in conjunction with the accompanying drawings. It is evident that the implementations described herein are merely some rather than all of the implementations of the disclosure. Those of ordinary skill in the art will be able to derive other implementations based on these implementations without creative work, and all such derived implementations shall fall in the protection scope of the disclosure.

The terms “first” and “second” used in the specification, the claims, and the accompany drawings of the present disclosure are used to distinguish different objects rather than describe a particular order. The terms “include”, “comprise”, and “have” as well as variations thereof are intended to cover non-exclusive inclusion. For example, a process, method, system, product, or apparatus including a series of steps or units is not limited to the listed steps or units, on the contrary, it can optionally further include other steps or units that are not listed; alternatively, other steps or units inherent to the process, method, product, or device can be included either.

The term “embodiment” or “implementation” referred to herein means that a particular feature, structure, or characteristic described in connection with the implementation may be contained in at least one implementation of the present disclosure. The phrase appearing in various places in the specification does not necessarily refer to the same implementation, nor does it refer an independent or alternative implementation that is mutually exclusive with other implementations. It is expressly and implicitly understood by those skilled in the art that an implementation described herein may be combined with other implementations.

The following describes the method implementations of the present disclosure in detail.

A method for assigning an installation task is provided. In this method, in response to a start signal for an installation task of an application detected, available processor resources are queried according to operation levels of processor resources. The installation task is assigned to the available processor resources for executing when the available processor resources are queried. A performance index of the available processor resources is improved. This method will be depicted in detail with reference to the accompany drawings in the following.

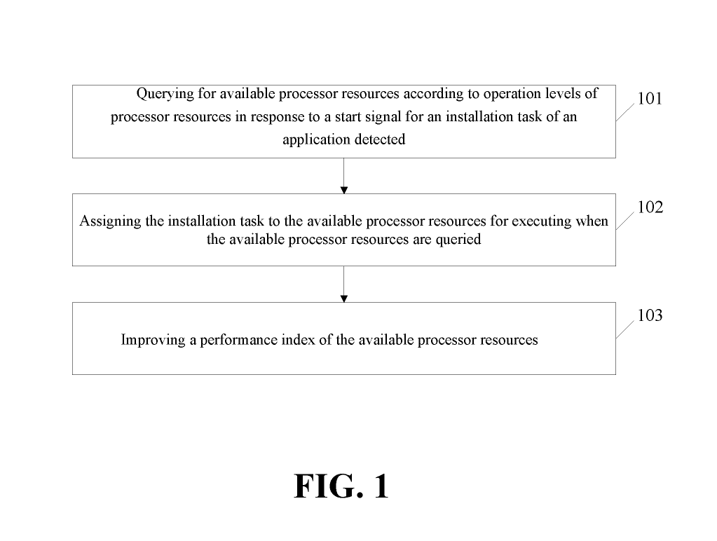

Referring to FIG. 1, FIG. 1 is a schematic flow chart illustrating a method for assigning an installation task according to an implementation of the disclosure. The method can be implemented by a terminal device. As illustrated in FIG. 1, the method starts at block 101.

At block 101, available processor resources are queried according to operation levels of processor resources in response to a start signal for an installation task of an application detected.

In one implementation, when the start signal for the installation task of the application is detected, the available processor resources can be queried in descending order of the operation levels of the processor resources. In particular, the expression of detecting the start signal for the installation task of the application may refer to detecting a start signal for starting an installation process of the application, or may refer to detecting an acknowledgement signal for starting the installation task of the application from a user, where the acknowledgement signal can be deemed as the start signal for the installation task of the application. After any kind of the foregoing start signal is detected, the available processor resources can be queried according to the operation levels of the processor resources. In one implementation, processor resources with a higher operation level can be first queried. When available resources of the processor resources with the higher operation level are able to execute the installation task, the processor resources with the higher operation level can be determined as the available processor resource. Otherwise, when the available resources of the processor resources with the higher operation level are not sufficient to execute the installation task, continue to query processor resources with other operation levels to obtain processor resources that can currently execute the installation task. In one implementation, processor resources with an operation level corresponding to the load amount of the installation task can be determined according to the load amount of the installation task, for example, the smaller the load amount of the installation task, the lower the operation level of the processor resource. In one implementation, query for available resources of processor resources with an operation level corresponding to the load amount. When the processor resources with the operation level corresponding to the load amount cannot handle the load amount, processor resources with other operation levels can be further queried. There is no doubt that processor resources with higher operation levels can be queried first either. Available processor resources can be queried in other manners and the disclosure is not limited thereto. It should be noted that the processor resources described in the implementations of the disclosure may include at least one core processing unit. Core processing units of the processor resources can be integrated into the same processor or may be configured at different processors. Core processing units of the same processor resources may have the same or different operation levels. For example, in the processor resource, a core processing unit having a better operation capability will accordingly have a higher operation level.

At block 102, the installation task is assigned to the available processor resources for executing when the available processor resources are queried.

In one implementation, when the available processor resources are queried, the installation task can be assigned to the available processor resources queried for executing. In particular, when the available processor resources are queried, it indicates that the available processor resources can carry the load amount of the installation task. Then the installation task can be assigned to the available processor resources for executing.

At block 103, a performance index of the available processor resources is improved.

In one implementation, after the installation task is assigned to the available processor resources for executing, the performance index of the available processor resources can be improved. In one implementation, the performance index of the available processor resources can be improved by increasing the number of core processing units of the available processor resource, by increasing a clock frequency (dominant Frequency, also known as clock speed) of at least one core processing unit of the available processor resources to improve the performance of the available processor resources, or by turning off a low power mode for the available processor resources to improve the performance thereof when the available processor resources are currently in the low power mode, such that the installation task can be executed quickly. Moreover, improving of the performance index of the available processor resources can also be achieved through a combination of one or more manners described above. In one implementation, before improving the performance index of the available processor resource, a performance index to-be-adjusted of the available processor resources can be determined. The performance index of the available processor resources can be determined according to at least one of: the threshold number of core processing units, operation modes, and a threshold clock frequency of the available processor resources. For example, if the core processing units are not fully used, the number of core processing units can be determined as the performance index to-be-adjusted. Still another example, if a clock frequency of the available processor resources has not been adjusted to the highest value, the clock frequency may be determined as the performance index to-be-adjusted. After the performance index to-be-adjusted is determined, it can be increased to improve the performance of the available processor resource.

It is to be noted that when the available processor resources are queried, this is no limit to the execution manner such as the sequence of operations at block 102 and at block 103. For example, when the available processor resources are queried, the performance index of the available processor resources can be increased first and then the installation task is assigned to the available processor resources for executing. Alternatively, the operations at block 102 and at block 103 can be performed in parallel, or the performance index of the available processor resources can be improved after the installation task is assigned to the available processor resources for executing. In one implementation, after the installation task is assigned to the available processor resource, further monitor a moment at which the available processor resources are about to execute the installation task. When the moment comes, improve the performance of the available processor resource. In this way, power consumption of the processor resources can be reduced under the premise of ensuring fast executing of installation tasks.

According to implementations of the disclosure, when the start signal for the installation task of the application is detected, the available processor resources are queried according to the operation levels of the processor resources. The installation task is assigned to the available processor resources for executing when the available processor resources are queried. The performance index of the available processor resources is improved. As such, available processor resources can be reasonably allocated to the installation task and an executing speed of the installation task can be improved. In addition, the executing speed of the installation task can be further improved by improving the performance index of the available processor resources. In this way, the installation task of the application can be assigned to effective processor resources for quick executing, thereby improving the installation speed of the application and further improving user experience.

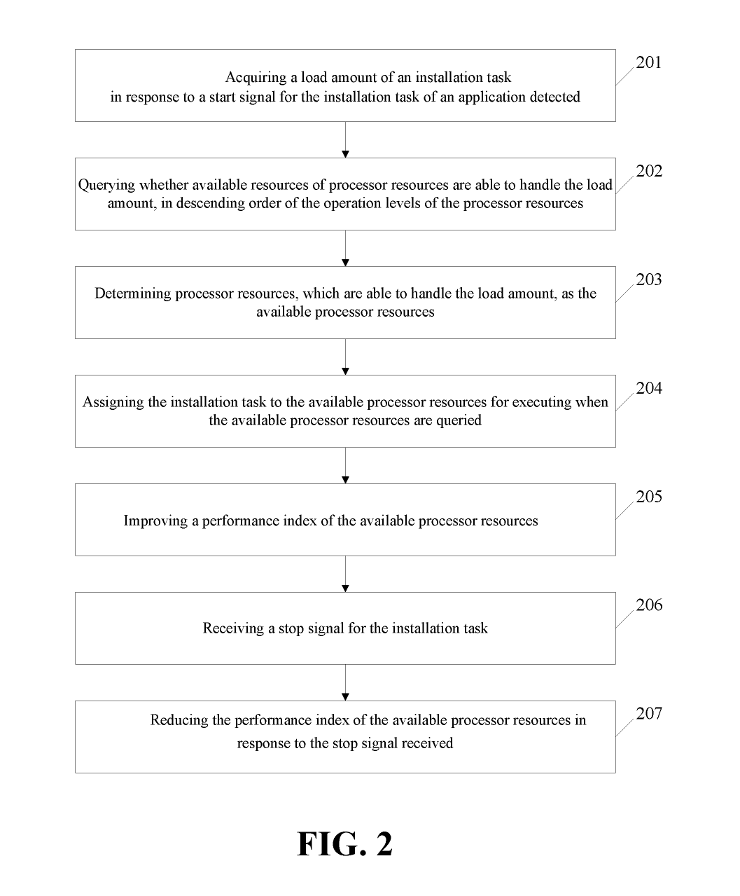

Referring to FIG. 2, FIG. 2 is a schematic flow chart illustrating a method for assigning an installation task according to an implementation of the disclosure. The method can be implemented by a terminal device. As illustrated in FIG. 2, the method starts at block 201. In FIG. 2, compared with the method of FIG. 1, operations regarding how to query for available processor resources and post-operations of performance index improving are illustrated.

At block 201, similar to operations at block 101, in response to a start signal for an installation task of an application detected, a load amount of the installation task is acquired.

In one implementation, when the start signal for the installation task of the application is detected, the load amount of the installation task can be acquired. In particular, the expression of detecting the start signal for the installation task of the application may refer to detecting a start signal for starting an installation process of an application, or may refer to detecting an acknowledgement signal for starting the installation task of the application started from a user, where the acknowledgement signal can be deemed as the start signal for the installation task of the application. After any kind of the foregoing start signal is detected, the load amount of the installation task can be acquired. Processor resources corresponding to the installation task can be determined according to the load amount of the installation task. The load amount of the installation task is associated with available resources, a residual amount of processor resources, or operation capability of the processor resources.

The following operations at block 202-block 204 of FIG. 2 correspond to that of block 102 of FIG. 1.

At block 202, whether available resources of processor resources are able to handle the load amount is queried, in descending order of the operation levels of the processor resources.

In one implementation, after the load amount of the installation task is acquired, whether the available resources of the processor resources are able to handle the load amount is queried, in descending order of operation levels of the processor resources for example. In particular, operation levels of the processor resources can be determined according to operation capabilities of the processor resources. The better the operation capability, the higher the operation level. The operation capability of the processor resources can be determined according to the number of core processing units and/or operation capability of the core processing units included in the processor resource. A larger number of core processing units included in the processor resources and a better operation capability of the core processing units will lead to a higher operation level of the processor resources. Alternatively, the total amount of tasks to be carried by the core processing units included in the processor resources can be counted. The larger the total amount of tasks, the higher the load amount that the processor resources can handle, and the higher the operation level of the processor resources. The processor resources may be sorted according to the operation levels in advance. When the start signal for the installation task is detected, query available processor resources according to the sorting result. Processor resources with a high operation level will be queried first. Residual amount of the processor resources can be queried and then compared with a load amount of an installation task of an application. When the residual amount of processor resources is equal to or greater than the load amount of the installation task of the application, it indicates that the processor resources are available. For example, a residual amount of the available resources of the processor resources is compared with the load amount, and determine that the processor resources are able to handle the load amount when the residual amount is equal to or greater than the load amount. In this way, the available processor resources can be acquired.

At block 203, processor resources, which are able to handle the load amount, are determined as the available processor resources.

In one possible implementation, instead of performing foregoing operations at S201-S203, the following operations can be performed.

A load amount of the installation task is acquired. Whether available resources of processor resources with an operation level corresponding to the load amount are able to handle the load amount is judged. The processor resources with the operation level corresponding to the load amount are determined as the available processor resources based on a judgment that the available resources of the processor resources with the operation level corresponding to the load amount are able to handle the load amount. Whether available resources of processor resources with other operation levels are able to handle the load amount is queried based on a judgment that the available resources of the processor resources with the operation level corresponding to the load amount are unable to handle the load amount. The processor resources with the other operation levels are determined as the available processor resources when the available resources of the processor resources with the other operation levels are able to handle the load amount.

After the load amount of the installation task is acquired, processor resources corresponding to the load amount can be determined, specifically, processor resources with an operation level corresponding to the load amount are determined. For example, if the installation task has a large load amount, the processor resources corresponding thereto will have a higher operation level. In one implementation, first determine whether the processor resources with the operation level corresponding to the load amount are available, that is, are able to handle the load amount. When the processor resources with the operation level corresponding to the load amount are unable to handle the load amount, further query whether processor resources of other operation levels are able to handle the load amount. For example, residual amount of processor resources is compared with the load amount of the installation task. When the residual amount of the processor resources is greater than the load amount, it indicates that the processor resources can carry the load amount of the installation task and therefore, the processor resources are available. In this way, the available processor resources can be determined.

At block 204, the installation task is assigned to the available processor resources for executing when the available processor resources are queried.

In one implementation, when the available processor resources are queried, the installation task is assigned to the available processor resources queried for executing. In particular, when the available processor resources are queried, it indicates that the available processor resources can carry the load amount of the installation task. Therefore, the installation task can be assigned to the available processor resources for executing.

At block 205, a performance index of the available processor resources is improved.

In one implementation, after the installation task is assigned to the available processor resources for executing, the performance index of the available processor resources can be improved. In one implementation, the performance index of the available processor resources can be improved by increasing the number of core processing units of the available processor resource, or by increasing a clock frequency (main frequency) of at least one core processing unit of the available processor resources to improve the performance of the available processor resource, or by turning off a low power mode for the available processor resources to improve the performance thereof when the available processor resources are currently in the low power mode, such that the installation task can be executed quickly. Moreover, improving of the performance index of the available processor resources can also be achieved through a combination of one or more manners described above. In one implementation, before improving the performance index of the available processor resource, a performance index to-be-adjusted of the available processor resources can be determined. For example, if the core processing units are not fully used, the number of core processing units can be used as the performance index to-be-adjusted. Still another example, if a clock frequency of the available processor resources has not been adjusted to the highest value, the clock frequency may be determined as the performance index to-be-adjusted. After the performance index to-be-adjusted is determined, it can be increased to improve the performance of the available processor resources.

It is to be noted that when the available processor resources are queried, this is no limit to the execution sequence of operations at block 204 and block 205. For example, when the available processor resources are queried, the performance index of the available processor resources can be increased first and then the installation task is assigned to the available processor resources for executing. Alternatively, the operations at block 204 and block 205 can be performed in parallel, or the performance index of the available processor resources can be improved after the installation task is assigned to the available processor resources for executing. In one implementation, after the installation task is assigned to the available processor resources, further monitor a moment at which the available processor resources are about to execute the installation task. When the moment comes, improve the performance of the available processor resources. In this way, power consumption of the available processor resources can be reduced under the premise of ensuring fast executing of installation tasks. In one implementation, after the installation task is assigned to the available processor resources, if a clock frequency of the available processor resources to be adjusted can be determined, then at least one core processing unit configured to execute the installation task can be determined; further, an increase in the clock frequency corresponding to the load amount can be determined according to the load amount of the installation task. A correspondence between the increase in the clock frequency and the load amount of the installation task can be stored in the terminal device in advance. Based on this, a clock frequency of the at least one core processing unit can be improved according to the increase in the clock frequency determined. When there are multiple core processing units for executing the installation task, for each core processing unit, the increase in the clock frequency can be determined according to a load amount assigned thereto. That is to say, an increase in the clock frequency for each core processing unit can be the same or different.

At block 206, a stop signal for the installation task is received.

In one implementation, after the performance index of the available processor resources is improved and the installation task is executed, further judge whether the stop signal for the installation task is detected. The stop signal may be a stop signal issued after the installation task is completed. When the stop signal is received, it indicates that the available processor resources have completed the execution of the installation task and the performance index of the available processor resources can be restored or reduced according to the current load amount.

In one implementation, a detection timer may be set and the reception of the above stop signal can be monitored within a timing period of the detection timer. If no stop signal is monitored during the timing period of the detection timer, it can be considered that no stop signal is detected.

When no stop signal is detected for example within the preset time period, it indicates that the installation task fails or no stop signal is normally issued after the installation task is completed. In such a situation, the performance index of the available processor resources can be reduced automatically at the end of the preset time period, so as to avoid excessive power consumption caused by improving the performance of the available processor resources for a long time.

At block 207, the performance index of the available processor resources is reduced or restored in response to the stop signal received.

In one implementation, the performance index of the available processor resources is reduced as follows. The performance index of the available processor resources can be restored to the one before the increase (that is, before the improving at block 205). For example, if available processor resources before increase are in a low power mode, then reducing the performance index of the available processor resources may refer to restoring the available processor resources to the low power mode. In another case, a current load amount that is currently handled by the available processor resources may be first detected, then the performance index to-be-adjusted of the available processor resources may be determined according to the current load amount, and further an adjustment amount of the performance index to-be-adjusted may be determined according to the current load amount, such that the performance index to-be-adjusted can be adjusted according to the adjustment amount determined. In one implementation, the current load amount that is currently handled by the available processor resources is detected, and whether all core processing units that are currently running in the available processor resources are processing loads is determined. When there is a core processing unit(s) that is currently running but not processing loads, or there is a core processing unit(s) that is processing small loads, determine a clock frequency or a power consumption state of the core processing unit as the performance index to-be-adjusted. In this way, the clock frequency or the power consumption state of the core processing unit can be reduced. When the core processing unit is processing small loads, the adjustment amount can be determined according to the load amount of the loads that is currently handled by the core processing unit.

According to the implementations of the disclosure, when the start signal for the installation task of the application is detected, the available processor resources are queried according to the operation levels of the processor resources. The installation task is assigned to the available processor resources for executing when the available processor resources are queried. The performance index of the available processor resources is improved. As such, available processor resources can be reasonably allocated to the installation task and an executing speed of the installation task can be improved. In addition, the executing speed of the installation task can be quickly increased by improving the performance index of the processor resource. In this way, the installation task of the application can be assigned to effective processor resources for quick executing, thereby improving the installation speed of the application and further improving the user experience.

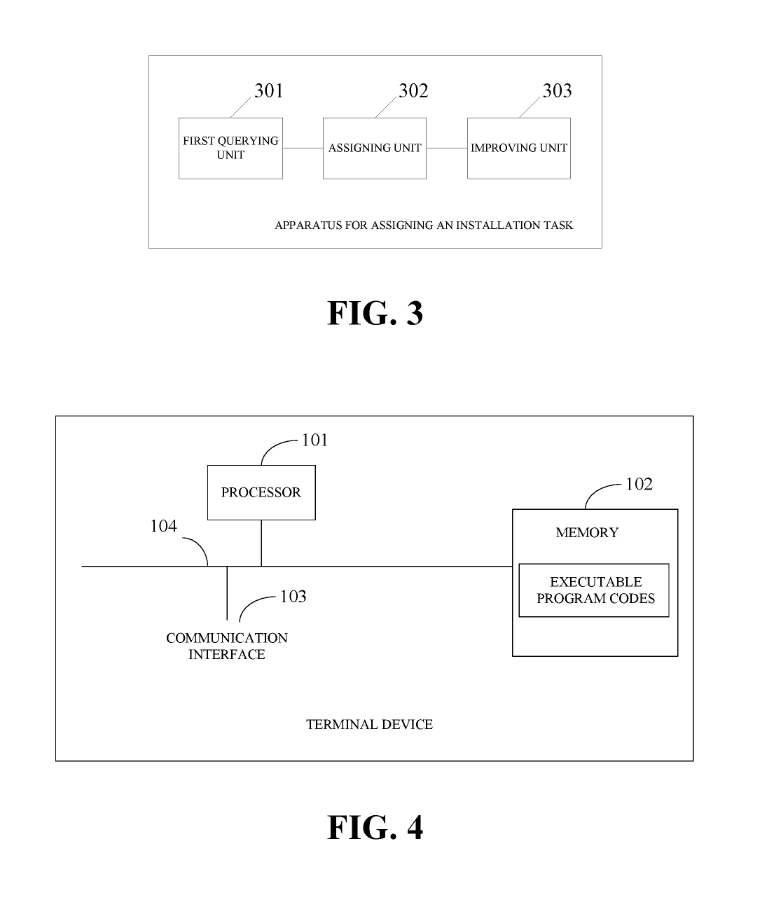

Referring to FIG. 3, FIG. 3 is a block diagram illustrating functional units of an apparatus for assigning an installation task according to an implementation of the disclosure. The apparatus includes a first querying unit 301, an assigning unit 302, and an improving unit 303. The foregoing functional units as well as other functional units depicted in the following can be integrated into a processor for example.

The first querying unit 301 is configured to query for available processor resources according to operation levels of processor resources in response to a start signal for an installation task of an application detected.

The assigning unit 302 is configured to assign the installation task to the available processor resources for executing, when the first querying unit 301 queries the available processor resources.

The improving unit 303 is configured to improve a performance index of the available processor resources.

In one implementation, the first querying unit 301 includes a first acquiring unit, a second querying unit, and a first determining unit. The first acquiring unit is configured to acquire a load amount of the installation task. The second querying unit is configured to query whether available resources of the processor resources are able to handle the load amount, in descending order of the operation levels of the processor resources. The first determining unit is configured to determine processor resources as the available processor resources when the second querying unit queries that the processor resources are able to handle the load amount.

In another implementation, the first querying unit includes a second acquiring unit, a first judging unit, a second determining unit, a third querying unit, and a third determining unit. The second acquiring unit is configured to acquire a load amount of the installation task. The first judging unit is configured to judge whether available resources of processor resources with an operation level corresponding to the load amount are able to handle the load amount. The second determining unit is configured to determine the processor resources with the operation level corresponding to the load amount as the available processor resources when the first judging unit judges that the available resources of the processor resources with the operation level corresponding to the load amount are able to handle the load amount. The third querying unit is configured to query whether available resources of processor resources with other operation levels are able to handle the load amount when the first judging unit judges that the available resources of the processor resources with the operation level corresponding to the load amount are unable to handle the load amount. The third determining unit is configured to determine the processor resources with the other operation levels as the available processor resources when the third querying unit queries that the available resources of the processor resources with the other operation levels are able to handle the load amount.

In one implementation, the improving unit configured to improve the performance index of the available processor resources is configured to: increase the number of core processing units of the available processor resources; or turn off a low power mode for the available processor resources; or increase a clock frequency of the available processor resources according to the load amount of the installation task.

In one implementation, the improving unit configured to increase the clock frequency of the available processor resources according to the load amount of the installation task is configured to: determine an increase in a clock frequency corresponding to the load amount according to the load amount of the installation task; determine, from among the available processor resources, at least one core processing unit configured to execute the installation task; adjust a clock frequency of the at least one core processing unit according to the increase in the clock frequency.

In one implementation, the apparatus further includes a second judging unit and a reducing unit. The second judging unit is configured to judge whether a stop signal for the installation task is detected within a preset time period after the improving unit improves the performance index of the available processor resources. The reducing unit is configured to reduce a performance index of the available processor resources when the second judging unit judges that no stop signal for the installation task is detected.

In one implementation, the reducing unit configured to reduce the performance index of the available processor resources is configured to: detect a current load amount that is currently handled by the available processor resources; determine a performance index to-be-adjusted for the available processor resources according to the current load amount and determine an adjustment amount of the performance index to-be-adjusted; adjust the performance index to-be-adjusted according to the adjustment amount.

According to the implementations of the disclosure, when the start signal for the installation task of the application is detected, the available processor resources are queried according to the operation levels of the processor resources. The installation task is assigned to the available processor resources for executing when the available processor resources are queried. The performance index of the available processor resources is improved. As such, available processor resources can be reasonably allocated to the installation task and an executing speed of the installation task can be improved. In addition, the executing speed of the installation task can be quickly improved by improving the performance index of the available processor resources. In this way, the installation task of the application can be assigned to effective processor resources for quick executing, thereby improving the installation speed of the application and further improving the user experience.

Implementations of the disclosure provide a terminal device. As illustrated in FIG. 4, the terminal device includes a processor 101, a memory 102, a communication interface 103, and a communication bus 104. The processor 101, the memory 102, and the communication interface 103 are coupled and communicate with each other though the communication bus 104. The processor 101 controls wireless communication with an external cellular network through the communication interface 103. The communication interface 103 includes but is not limited to an antenna, an amplifier, a transceiver, a coupler, a low noise amplifier (LNA), a duplexer and the like. In addition, the memory 102 may include at least one of a random access memory (RAM), a non-volatile memory, and an external memory. The memory 102 is configured to store executable program codes and the executable program codes can guide the processor 101 to perform the method for assigning an installation task disclosed in the method implementations of the present disclosure, where the method includes the following operations.

The processor 101 is configured to query for available processor resources according to operation levels of processor resources in response to a start signal for an installation task of an application detected. The processor 101 is configured to assign the installation task to the available processor resources for executing when the available processor resources are queried. The processor 101 is configured to improve a performance index of the available processor resources.

In one implementation, the performance index includes at least one of the number of core processing units, a low power mode, and a clock frequency.

In one implementation, the processor 101 is configured to: acquire a load amount of the installation task; compare the load amount with a residual amount of available resources of processor resources, in descending order of the operation levels of the processor resource; determine processor resources with a residual amount of available resources equal to or greater than the load amount as the available processor resources.

In one implementation, the processor 101 is configured to: acquire a load amount of the installation task; determine whether a residual amount of available resources of processor resources with an operation level corresponding to the load amount is less than the load amount; determine the processor resources with the operation level corresponding to the load amount as the available processor resources, based on a determination that the residual amount of the available resources is not less than the load amount. On the other hand, if the residual amount of the available resources is less than the load amount, the processor 101 is further configured to query for other processor resources with other operation levels, until the available processor resources are found.

The operation levels of the processor resources are associated with operation capacities of core processing units of the processor resources.

According to the implementation of the disclosure, when the start signal for the installation task of the application is detected, the available processor resources are queried according to the operation levels of the processor resources. The installation task is assigned to the available processor resources for executing when the available processor resources are queried. The performance index of the available processor resources is improved. As such, the installation task can be reasonably assigned to processor resources and an executing speed of the installation task can be improved. In addition, the executing speed of the installation task can be quickly improved by improving the performance index of the available processor resources. In this way, the installation task of the application can be assigned to effective processor resources for quick executing, thereby improving the installation speed of the application and further improving the user experience.

In addition, the executable program codes stored in the memory 102 are configured to perform related operations of the method illustrated in FIG. 2 above, which will not be repeated herein again.

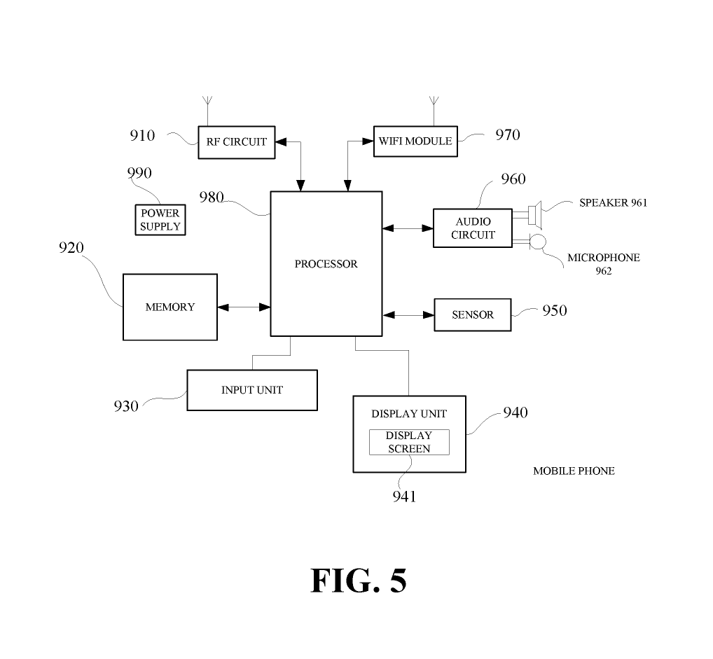

Implementations of the disclosure also provide another terminal device. As illustrated in FIG. 5, only parts related to the implementation of the disclosure are illustrated for the convenience of description. For technical details not described, reference may be made to the method implementations of the present disclosure. The terminal device may be any terminal device, such as a mobile phone, a tablet PC, a personal digital assistant (PDA), a point of sale terminal (POS), an on-board computer, and the like. The following describes a mobile phone as an example of the terminal device.

FIG. 5 is a block diagram illustrating a partial structure of a mobile phone related to a terminal device according to an implementation of the disclosure. Referring to FIG. 5, the mobile phone includes a radio frequency (RF) circuit 910, a memory 920, an input unit 930, a display unit 940, a sensor 950, an audio circuit 960, a wireless fidelity (Wi-Fi) module 970, a processor 980, and a power supply 990 and other components. Those skilled in the art can understand that the structure of the mobile phone illustrated in FIG. 5 does not constitute any limitation on a mobile phone. The mobile phone configured to implement technical solutions of the disclosure may include more or fewer components than illustrated, or may combine certain components or different components.

In the following, various components of the mobile phone will be described in detail with reference to FIG. 5.

The RF circuit 910 is configured to receive or transmit information. Generally, the RF circuit 910 includes but is not limited to an antenna, at least one amplifier, a transceiver, a coupler, a low noise amplifier (LNA), a duplexer and the like. In addition, the RF circuit 910 may also communicate with the network or other devices via wireless communication. The above wireless communication may use any communication standard or protocol, which includes but is not limited to global system of mobile communication (GSM), general packet radio service (GPRS), code division multiple access (CDMA), wideband code division multiple access (WCDMA), long term evolution (LTE), E-mail, short messaging service (SMS) and so on.

The memory 920 is configured to store software programs and modules. The processor 980 is configured to execute various function applications and data processing of the mobile phone by running the software programs and the modules stored in the memory 920. The memory 920 may mainly include a program storage area and a data storage area. The program storage area may store an operating system, applications required for at least one function, and the like. The data storage area may store data created according to the use of the smart phone, and the like. In addition, the memory 920 may include a high-speed random access memory (RAM), and may further include a non-transitory memory such as at least one disk storage device, a flash device, or other non-transitory solid storage devices.

The input unit 930 is configured to receive input digital or character information and generate key signal input associated with user setting and function control of the mobile phone. The input unit 930 may include at least one of a physical keyboard, a function key (such as a volume control key, a switch key, etc.), a trackball, a mouse, a joystick, and a fingerprint recognition module and the like.

The display unit 940 is configured to display information input by a user or information provided for the user or various menus of the mobile phone. The display unit 940 may include a display screen 941. Alternatively, the display screen 941 may be in the form of a liquid crystal display (LCD), an organic light-emitting diode (OLED) and so on.

The mobile phone may further include at least one sensor 950, such as a light sensor, a motion sensor, and other sensors. As one implementation, the light sensor may include an ambient light sensor and a proximity sensor, among which the ambient light sensor may adjust brightness of the display screen 941 according to ambient lights. The proximity sensor may turn off the display screen 941 and/or backlight when the mobile phone reaches nearby the ear. As a kind of the motion sensor, a accelerometer sensor can detect the magnitude of acceleration in all directions (typically three axes) and when the mobile phone is stationary, the accelerometer sensor can detect the magnitude and direction of gravity; the accelerometer sensor can also identify mobile-phone gestures related the applications (such as vertical and horizontal screen switch, related games, magnetometer attitude calibration), or the accelerometer sensor can be used for vibration-recognition related functions (such as a pedometer, percussion) and so on. The mobile phone can also be equipped with a gyroscope, a barometer, a hygrometer, a thermometer, and an infrared sensor and other sensors, and it will not be repeated herein.

The audio circuit 960, a speaker 961, and a microphone 962 may provide an audio interface between the user and the mobile phone. The audio circuit 960 may convert the received audio data into electrical signals and transfer the electrical signals to the speaker 961; thereafter the speaker 961 converts the electrical signals into sound signals to output. On the other hand, the microphone 962 converts the received sound signals into electrical signals, which will be received and converted into audio data by the audio circuit 960 to output. The audio data is then processed and transmitted by the general-purpose processor 980 via the RF circuit 910 to another mobile phone for example, or, the audio data is output to the memory 920 for further processing.

Wi-Fi belongs to a short-range wireless transmission technology. With aid of the Wi-Fi module 970, the mobile phone may assist the user in E-mail receiving and sending, webpage browsing, access to streaming media and the like. Wi-Fi provides users with wireless broadband Internet access. Although the Wi-Fi module 970 is illustrated in FIG. 5, it should be understood that the Wi-Fi module 970 is not essential to the mobile phone and can be omitted according to actual needs without departing from the essential nature of the present disclosure.

The processor 980 is a control center of the mobile phone. The processor 980 is configured to connect various parts of the entire smart phone through various interfaces and lines, run or execute software programs and/or modules stored in the memory 920, and invoke data stored in the memory 920, to execute various functions of the smart phone and process data, thereby monitoring the smart phone as a whole. In at least one implementation, the processor 980 may include at least one processing unit. For example, the processor 980 can be integrated with an application processor and a modem processor, where the application processor is mainly configured to handle and maintain an operating system, a user interface, applications, and so on. The modem processor is mainly configured to process wireless communication. It will be appreciated that the above-mentioned modem processor mentioned above may not be integrated into the processor 980.

The mobile phone also includes a power supply 990 (e.g., a battery) that supplies power to various components. For instance, the power supply 990 may be logically connected to the processor 980 via a power management system to enable management of charging, discharging, and power consumption through the power management system.

Although not illustrated, the mobile phone may further include a camera, a Bluetooth module, etc., and the disclosure will not elaborate herein.

In the foregoing implementation illustrated in FIG. 1 or FIG. 2, the process flow of each method may be implemented based on the structure of the mobile phone.

In the foregoing implementation illustrated in FIG. 3, each unit function can be implemented based on the structure of the mobile phone.

Implementations of the present disclosure also provide a computer storage medium. The computer storage medium stores programs which, when executed, are operable to accomplish all or part of the operations of any of the methods described in the above-described method implementation.

It is to be noted that, for the sake of simplicity, the foregoing method implementations are described as a series of action combinations, however, it will be appreciated by those skilled in the art that the present disclosure is not limited by the sequence of actions described. According to the present disclosure, certain steps or operations may be performed in other order or simultaneously. Besides, it will be appreciated by those skilled in the art that the implementations described in the specification are exemplary implementations and the actions and modules involved are not necessarily essential to the present disclosure.

In the foregoing implementations, the description of each implementation has its own emphasis. For the parts not described in detail in one implementation, reference may be made to related descriptions in other implementations.

In the implementations of the disclosure, it should be understood that, the apparatus disclosed in implementations provided herein may be implemented in other manners. For example, the device/apparatus implementations described above are merely illustrative; for instance, the division of the unit is only a logical function division and there can be other manners of division during actual implementations, for example, multiple units or components may be combined or may be integrated into another system, or some features may be ignored, omitted, or not performed. In addition, coupling or communication connection between each illustrated or discussed component may be direct coupling or communication connection, or may be indirect coupling or communication among devices or units via some interfaces, and may be electrical connection, mechanical connection, or other forms of connection.

The units described as separate components may or may not be physically separated, the components illustrated as units may or may not be physical units, that is, they may be in the same place or may be distributed to multiple network elements. All or part of the units may be selected according to actual needs to achieve the purpose of the technical solutions of the implementations.

In addition, the functional units in various implementations of the present disclosure may be integrated into one processing unit, or each unit may be physically present, or two or more units may be integrated into one unit. The above-mentioned integrated unit can be implemented in the form of hardware or a software functional unit.

The integrated unit may be stored in a computer-readable memory when it is implemented in the form of a software functional unit and is sold or used as a separate product. Based on such understanding, the technical solutions of the present disclosure essentially, or the part of the technical solutions that contributes to the related art, or all or part of the technical solutions, may be embodied in the form of a software product which is stored in a memory and includes instructions for causing a computer device (which may be a personal computer, a server, or a network device and so on) to perform all or part of the steps described in the various implementations of the present disclosure. The memory includes various medium capable of storing program codes, such as a USB (universal serial bus) flash disk, a read-only memory (ROM), a random access memory (RAM), a removable hard disk, Disk, compact disc (CD), or the like.

It will be understood by those of ordinary skill in the art that all or a part of the various methods of the implementations described above may be accomplished by means of a program to instruct associated hardware, the program may be stored in a computer-readable memory, which may include a flash memory, a read-only memory (ROM), a random-access memory (RAM), a disk or a compact disc (CD), and so on.

While the present disclosure has been described in detail above with reference to the exemplary implementations, the scope of the present disclosure is not limited thereto. As will occur to those skilled in the art, the present disclosure is susceptible to various modifications and changes without departing from the spirit and principle of the present disclosure. Therefore, the scope of the present disclosure should be determined by the scope of the claims.

What is claimed is:

1. A method for assigning an installation task, comprising:
querying for available processor resources according to operation levels of processor resources in response to a start signal for an installation task of an application detected;
assigning the installation task to the available processor resources for executing when the available processor resources are queried; and
improving a performance index of the available processor resources.

2. The method of claim 1, wherein querying for the available processor resources according to the operation levels of processor resources comprises:
acquiring a load amount of the installation task;
querying whether available resources of processor resources are able to handle the load amount, in a descending order of the operation levels of the processor resources; and
determining processor resources, the processor resources being able to handle the load amount, as the available processor resources.

3. The method of claim 2, wherein querying whether the available resources of the processor resources are able to handle the load amount comprises:
comparing a residual amount of the available resources of the processor resources with the load amount; and
determining that the processor resources are able to handle the load amount when the residual amount is equal to or greater than the load amount.

4. The method of claim 1, wherein querying for the available processor resources according to the operation levels of processor resources comprises:
acquiring a load amount of the installation task;
determining whether available resources of processor resources with an operation level corresponding to the load amount are able to handle the load amount;
determining the processor resources with the operation level corresponding to the load amount as the available processor resources, based on a determination that the available resources of the processor resources with the operation level corresponding to the load amount are able to handle the load amount;
querying whether available resources of processor resources with other operation levels are able to handle the load amount, based on a determination that the available resources of the processor resources with the operation level corresponding to the load amount are unable to handle the load amount; and
determining the processor resources with the other operation levels as the available processor resources, when the available resources of the processor resources with the other operation levels are able to handle the load amount.

5. The method of claim 1, wherein improving the performance index of the available processor resources comprises:
monitoring a moment when the available processor resources are about to execute the installation task; and
improving the performance index of the available processor resources when the moment comes.

6. The method of claim 1, wherein improving the performance index of the available processor resources comprises one of:
increasing the number of core processing units of the available processor resources;
turning off a low power mode for the available processor resources; and
increasing a clock frequency of the available processor resources according to a load amount of the installation task.

7. The method of claim 6, wherein increasing the clock frequency of the available processor resources according to the load amount of the installation task comprises:
determining an increase in a clock frequency corresponding to the load amount, according to the load amount of the installation task;
determining, from among the available processor resources, at least one core processing unit configured to execute the installation task; and
adjusting a clock frequency of the at least one core processing unit, according to the increase in the clock frequency.

8. The method of claim 1, further comprising:
after improving the performance index of the available processor resources:
receiving a stop signal for the installation task; and
reducing the performance index of the available processor resources or restoring the performance index to the one before the improving, in response to the stop signal.

9. The method of claim 8, wherein reducing the performance index of the available processor resources comprises:
detecting a current load amount that is currently handled by the available processor resources;
determining a performance index to-be-adjusted for the available processor resources according to the current load amount and determining an adjustment amount of the performance index to-be-adjusted; and
reducing the performance index to-be-adjusted according to the adjustment amount.

10. The method of claim 1, further comprising:
after improving the performance index of the available processor resources, reducing the performance index of the available processor resources or restoring the performance index to the one before the improving, when a preset time period has elapsed since the improving.

11. The method of claim 1, further comprising:
determining the operation levels of the processor resources according to operation capacities thereof, wherein the operation capacities are determined according to at least one of the number of core processing units, operation capacities of the core processing units, and total loads carried by the core processing units.

12. The method of claim 1, wherein the available processor resources comprise at least one core processing unit configured to execute tasks.

13. The method of claim 1, further comprising:
determining the performance index of the available processor resources according to at least one of: a threshold number of core processing units, operation modes, and a threshold clock frequency of the available processor resources.

14. A terminal device, comprising:
at least one processor; and
a computer readable storage, coupled to the at least one processor and storing at least one computer executable instruction thereon which, when executed by the at least one processor, cause the device to:
query for available processor resources according to operation levels of processor resources in response to a start signal for an installation task of an application detected;
assign the installation task to the available processor resources queried; and
improve a performance index of the available processor resources.

15. The terminal device of claim 14, wherein the performance index comprises at least one of the number of core processing units, a low power mode, and a clock frequency.

16. The terminal device of claim 14, wherein the at least one computer executable instruction causing the at least one processor to query for the available processor resources according to the operation levels of the processor resources further cause the at least one processor to:
acquire a load amount of the installation task;
compare the load amount with a residual amount of available resources of processor resources, in descending order of the operation levels of the processor resources; and
determine processor resources with a residual amount of available resources equal to or greater than the load amount as the available processor resources.

17. The terminal device of claim 14, wherein the at least one computer executable instruction causing the at least one processor to query for the available processor resources according to the operation levels of the processor resources further cause the at least one processor to:
acquire a load amount of the installation task;
determine whether a residual amount of available resources of processor resources with an operation level corresponding to the load amount is less than the load amount; and
determine the processor resources with the operation level corresponding to the load amount as the available processor resources, based on a determination that the residual amount of the available resources is not less than the load amount.

18. The terminal device of claim 14, wherein the at least one computer executable instruction causing the at least one processor to improve the performance index of the available processor resources further cause the at least one processor to perform at least one of:
increasing the number of core processing units of the available processor resources;
turning off a low power mode for the available processor resources; and
increasing a clock frequency of the available processor resources according to a load amount of the installation task.

19. The terminal device of claim 14, wherein the operation levels of the processor resources are associated with operation capacities of core processing units of the processor resources.

20. A non-transitory computer readable storage medium, storing at least one computer executable instruction, which, when executed by a computer, cause the computer to:
query for available processor resources according to operation levels of processor resources in response to a start signal for an installation task of an application detected;
assign the installation task to the available processor resources queried; and
improve a performance index of the available processor resources.
